(19) United States
(12) Patent Application Publication
(10) Pub. No.: US 2008/0080186 A1
(43) Pub. Date: Apr. 3, 2008

(54) OPTICAL PLATE FOR DISPLAY, BACKLIGHT ASSEMBLY HAVING THE SAME AND METHOD THEREOF

(75) Inventors: Ju Hwa HA, Seoul (KR); Jung Wook PAEK, Suwon-si (KR); Tae Seok JANG, Seoul (KR); Sang Hyuck YOON, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/865,181

(22) Filed: Oct. 1, 2007

(30) Foreign Application Priority Data
Sep. 29, 2006 (KR) 1020060095903

(51) Int. Cl. F21V 9/04; B05D 5/06; G02B 5/22

(52) U.S. Cl. 362/293; 359/359; 427/596

(57) ABSTRACT

An optical plate for a display and a backlight assembly having the optical plate, the optical plate including an optical layer including infrared ray absorbing members that absorb infrared rays in a wavelength range (e.g., about 850 nanometers (nm) to about 1400 nanometers (nm)) used by a remote control of a display device. The optical plate absorbs the infrared rays in the wavelength range included in irradiated infrared rays from the display device, such that emission to the outside of the display device of the infrared rays in the wavelength range is reduced or effectively prevented

This application claims priority to Korean Patent Application No. 2006-0095903, filed on Sep. 29, 2006, and all the benefits accruing therefrom under 35 U.S.C. §119, the disclosure of which is incorporated by reference herein in its entirety.

### BACKGROUND OF THE INVENTION

1. Field of the Invention

The present invention relates to an optical plate for a display device and a backlight assembly having the same. More particularly, the present invention relates to an optical plate for a display capable of blocking infrared (“IR”) rays, which are generated from a light source of a backlight assembly, through an infrared ray blocking function of the optical plate, and a backlight assembly having the optical plate.

2. Description of the Related Art

Since a liquid crystal display (“LCD”) cannot emit light by itself, visibility is lowered in a dark place. Thus, the LCD is provided with a light source such as a backlight. The LCD includes a backlight for generating light, and an LCD panel for displaying images thereon using the light from the backlight. As to a light source of the backlight, a cold cathode fluorescent lamp (“CCFL”) is employed. The CCFL emits light in an IR wavelength range as well as visible rays.

Meanwhile, TV products using LCDs are produced by incorporating various electronic devices. For example, a certain TV products include a home theater and a DVD player as well as an LCD. The electronic devices are controlled using a single remote control. The remote control uses light in an IR wavelength range to control operations of the electronic devices.

However, the infrared rays of the remote control interfere with infrared rays emitted from a CCFL used as a light source of a backlight of an LCD. Thus, there is a problem in that the electronic devices may not be controlled by the remote control. In particular, as the size of an LCD increases, the intensity of infrared rays emitted from the backlight also increases, thereby making this problem worse.

### BRIEF SUMMARY OF THE INVENTION

An exemplary embodiment provides an optical plate for a display, the optical plate being disposed above a light source of a backlight assembly that emits infrared rays and reduces or effectively prevents the infrared rays from being emitted outside the backlight assembly, and a backlight assembly having the optical plate.

An exemplary embodiment provides an optical plate for a display, the optical plate including a central layer including light diffusion materials, a skin layer disposed on the central layer and a coating layer disposed on the skin layer and including infrared ray absorbing members including one material of parylenes, antomony tin oxides, lanthanum hexaborides, zirconium dioxides and a combination including at least one of the foregoing.

In an exemplary embodiment, the infrared ray absorbing members may further include an organic dispersing agent and a resin. The optical plate may further include an optical sheet attached to the coating layer.

In an exemplary embodiment, the central layer and the skin layer may be made of the same kind or different kinds of light transmitting resin(s), the skin layer may be disposed at each of upper and lower surfaces of the central layer, and the coating layer may be disposed on at least one of the skin layers. The coating layer may be disposed on both of the skin layers.

An exemplary embodiment provides a method for manufacturing an optical plate for a display, the method including forming a diffusion plate including a central layer including light diffusion materials and skin layers disposed on upper and lower surfaces of the central layer, coating a light or thermal curing agent including infrared ray absorbing members on the diffusion plate, and curing the curing agent by irradiating light or heat, respectively, to the curing agent and forming a coating layer including the infrared ray absorbing members on the diffusion plate.

In an exemplary embodiment, the method may further include providing an optical sheet on the coating layer, irradiating laser rays in a wavelength range of about 850 nanometers (nm) to about 1400 nanometers (nm) and bonding the optical sheet to the coating layer.

An exemplary embodiment provides an optical plate for a display, the optical plate including a central layer including light diffusion materials, a skin layer disposed on the central layer, a film layer disposed on the skin layer, and a coating layer disposed on the film layer, connected to the skin layer and penetrating through the film layer, and including infrared ray absorbing members including one material of parylenes, antomony tin oxides, lanthanum hexaborides, zirconium dioxides and a combination including at least one of the foregoing.

In an exemplary embodiment, the film layer may have a plurality of through-holes, and the coating layer may extend into the through-holes to be connected to the skin layer.

In an exemplary embodiment, the infrared ray absorbing members may further include an organic dispersing agent and a resin. The optical plate may further include an optical sheet attached to the coating layer.

An exemplary embodiment provides a method for manufacturing an optical plate for a display, the method including forming a diffusion plate including a central layer including light diffusion materials and skin layers disposed on upper and lower surfaces of the central layer, disposing a film layer including a plurality of through-holes on the diffusion plate, coating a light or thermal curing agent including infrared ray absorbing members on the film layer, and curing the curing agent by irradiating light or heat, respectively, to the curing agent and forming a coating layer disposed on an upper surface of the film layer and disposed between the film layer and the skin layer while penetrating through the through-holes of the film layer.

In an exemplary embodiment, the method may further include providing an optical sheet on the coating layer and irradiating laser rays in a wavelength range of about 850 nanometers (nm) to about 1400 nanometers (nm) and bonding the optical sheet to the coating layer.

An exemplary embodiment provides an optical plate for a display, the optical plate including a central layer including light diffusion materials, a skin layer disposed on the central layer and including infrared ray absorbing members including one material of parylenes, antomony tin oxides, lanthanum hexaborides, zirconium dioxides and a combination including at least one of the foregoing, and an optical sheet bonded to the skin layer.

An exemplary embodiment provides a method for manufacturing an optical plate for a display, the method including injecting liquid resins such that a first liquid resin of a skin layer including infrared ray absorbing members is arranged on opposing sides of a second liquid resin of a central layer including light diffusion materials, curing the injected second resin of the central layer and the injected first resin of the skin layer to form the central layer including the light diffusion materials and skin layers including the infrared ray absorbing members, disposing an optical sheet on a formed skin layer including the infrared ray absorbing members, and irradiating infrared laser rays to the formed skin layer including the infrared absorbing members and bonding the optical sheet to the formed skin layer.

An exemplary embodiment provides a backlight assembly including a light source unit emitting light, an optical plate disposed above the light source unit and including infrared ray absorbing members including one material of parylenes, antomony tin oxides, lanthanum hexaborides, zirconium dioxides and a combination including at least one of the foregoing, and a receiving member receiving the light source unit and the optical plate.

In an exemplary embodiment, the optical plate may include a diffusion plate and a coating layer disposed on the diffusion plate and including the infrared ray absorbing members. The optical plate may include a diffusion plate, a film layer disposed on the diffusion plate and a coating layer including the infrared ray absorbing members and connected to an upper surface of the film layer and to a surface of the diffusion plate while penetrating through the film layer. The optical plate may include a central layer including light diffusion materials; skin layers disposed on upper and lower surfaces of the central layer and including the infrared ray absorbing members, and an optical sheet bonded to at least one of the skin layers.

An exemplary embodiment provides a liquid crystal display including a liquid crystal display panel displaying images thereon, a backlight assembly irradiating light to the liquid crystal display panel and a receiving member receiving the liquid crystal display panel and the backlight assembly. The backlight assembly includes a light source unit emitting light and an optical plate disposed above the light source unit and including a coating layer made of a light or thermal curing agent including infrared ray absorbing members.

In an exemplary embodiment, the infrared ray absorbing members may include one material of parylenes, antomony tin oxides, lanthanum hexaborides, zirconium dioxides and a combination including at least one of the foregoing.

### BRIEF DESCRIPTION OF THE DRAWINGS

The above and other features of the present invention will become apparent by describing in detail exemplary embodiments thereof with reference to the attached drawings, in which:

FIG. 1 is a schematic cross-sectional view showing an exemplary embodiment of an optical plate for a display according to the present invention;

FIGS. 2 and 3 are schematic cross-sectional views showing exemplary embodiments of an optical plate for a display related to the optical plate of FIG. 1 according to the present invention;

FIG. 4 is a schematic view illustrating an exemplary embodiment of a method for manufacturing the optical plate of FIG. 1 for a display according to the present invention;

FIG. 5 is a schematic cross-sectional view showing another exemplary embodiment an optical plate for a display according to the present invention;

FIG. 6 is a schematic view illustrating another exemplary embodiment of a method for manufacturing the optical plate of FIG. 5 for a display according to the present invention;

FIG. 7 is a schematic cross-sectional view showing another exemplary embodiment of an optical plate for a display according to the present invention;

FIG. 8 is a schematic cross-sectional view showing an exemplary embodiment of an optical plate for a display related to the optical plate of FIG. 7 according to the present invention;

FIG. 9 is a perspective view schematically showing an exemplary embodiment of a backlight assembly according to the present invention;

FIG. 10 is a perspective view schematically showing an exemplary embodiment of a backlight assembly related to the backlight assembly of FIG. 9 according to the present invention;

FIG. 11 is a perspective view schematically showing an exemplary embodiment of a liquid crystal display according to the present invention; and

FIG. 12 is a schematic cross-sectional view taken along line A-A in the liquid crystal display shown in FIG. 11.

### DESCRIPTION OF THE INVENTION

Hereinafter, exemplary embodiments of the present invention will be described in detail with reference to the accompanying drawings. However, the present invention is not limited to the exemplary embodiments but may be implemented into a variety of different forms. These exemplary embodiments are provided only for illustrative purposes and for full understanding of the scope of the present invention by those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

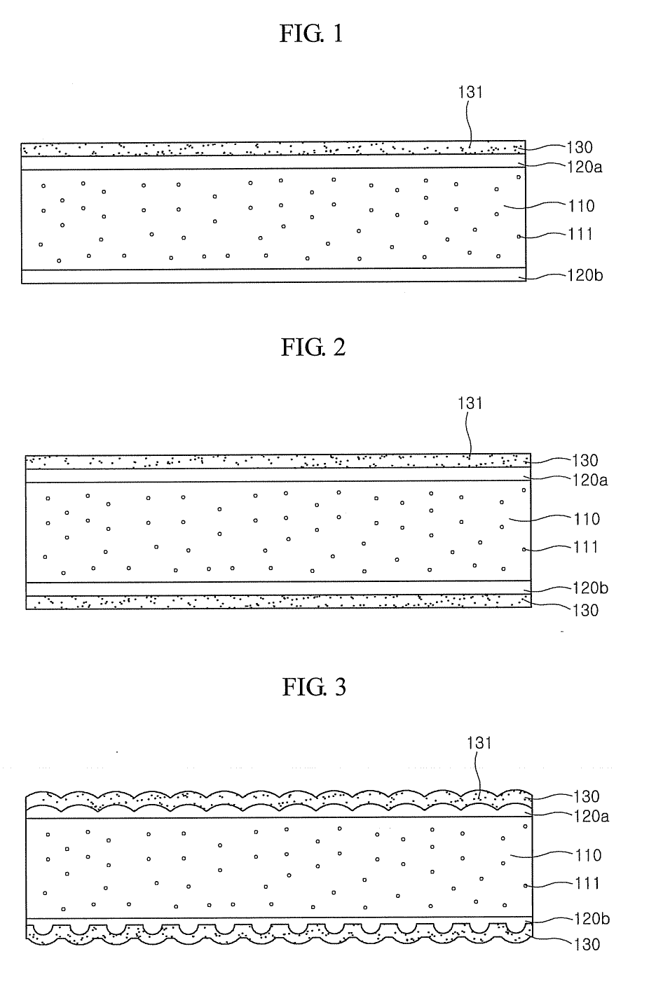

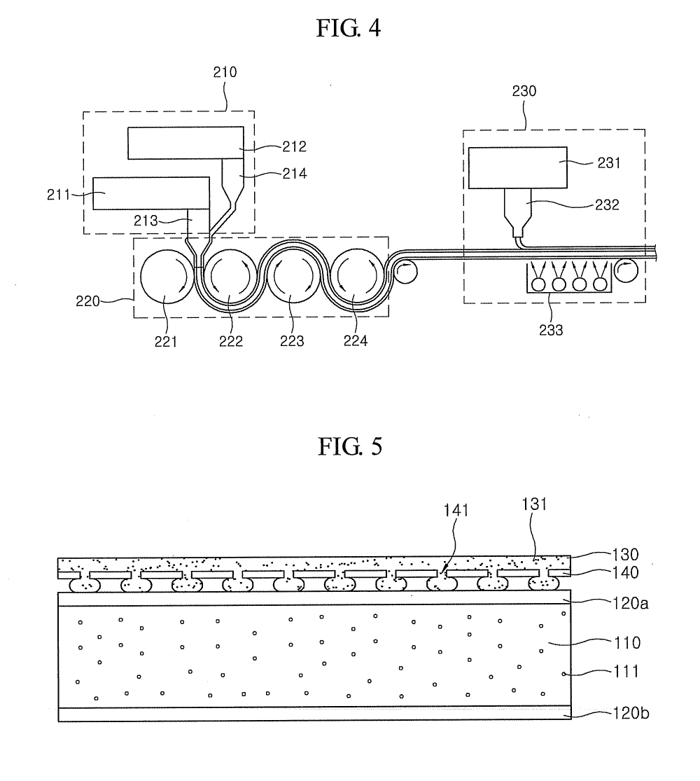

FIG. 1 is a schematic cross-sectional view showing an exemplary embodiment of an optical plate for a display according to the present invention. FIGS. 2 and 3 are schematic cross-sectional views showing an optical plate for a display related to the optical plate of FIG. 1 according to the present invention. FIG. 4 is a schematic view illustrating an exemplary embodiment of a method for manufacturing the optical plate for a display of FIG. 1 according to the present invention.

Referring to FIGS. 1 to 4, an optical plate for a display includes a central layer 110, skin layers 120 (120a, 120b) provided on upper and lower surfaces, respectively, of the central layer 110, and a coating layer 130 (FIG. 1) or coating layers 130 (FIGS. 2 and 3) provided on the skin layer 120. Light diffusion materials 111 are provided in the central layer 110. A material capable of selectively absorbing light with a certain wavelength is provided in the coating layer 130. In an exemplary embodiment, the material provided in the coating layer 130 may be infrared ray absorbing members 131 capable of absorbing infrared rays with a wavelength of about 850 nanometers (nm) to about 1400 nanometers (nm).

In the illustrated embodiment, the central layer 110 is made of a light transmitting resin provided with the light diffusion materials 111. Other additives for keeping mechanical properties and optical stability of the optical plate may be further added to the central layer 110. In one exemplary embodiment, the central layer 110 is made to have a thickness that is about 80% to about 99.9% of a total thickness of the optical plate. The light transmitting resin may include any of a number of materials suitable for the purposes described herein, such as PC (polycarbonate), PS (polystyrene resin), PET (polyethylene terephthalate), PAR (polyacrylate), PSU (polysulfone resin), PES (polyethersulfone resin), PP (polypropylene), PA (polyamide), PPS (polyphenylene sulfide), PI (polyimide resin), PEEK (poly ether-ether-ketone), PUR (polyurethane resin), PVC (polyvinyl chloride), PMP (methylpentane polymer), PMMA (polymethyl methacrylate), SI (silicone resin), acrylic resins, fluoro resins and a combination including at least one of the foregoing.

The skin layer 120 includes an upper skin layer 120a and a lower skin layer 120b provided on the upper and lower surfaces of the central layer 110, respectively. In an exemplary embodiment, the skin layer 120 may be made of the same light transmitting resin as the central layer 110. The skin layer 120 is not limited thereto, and may be made of a light transmitting resin different from that of the central layer 110. Any of a number of materials suitable for the purpose described herein, such as an antistatic agent, an antioxidant, an ultraviolet (UV) absorber, a flame retardant, a plasticizer, a colorant, a stabilizer, a lubricant and a combination including at least one of the foregoing, may be added to the skin layer 120 in exemplary embodiments. In one exemplary embodiment, each of the upper and lower skin layers 120a and 120b is made to have a thickness that is about 0.01% to about 10% of the total thickness of the optical plate.

In an exemplary embodiment, the coating layer 130 may be made by coating a UV-curing agent having the infrared ray absorbing members 131 onto the skin layer 120, and curing the coated agent through UV irradiation. The infrared ray absorbing members 131 absorb only infrared rays in a selected wavelength range. Advantageously, it is possible to reduce or effectively prevent transmission and emission of the light in this wavelength range from the optical plate. The infrared ray absorbing members 131 of the illustrated exemplary embodiment absorb light in a wavelength range of about 850 nm to about 1400 nm as mentioned above. In one exemplary embodiment, the infrared ray absorbing members 131 absorb light in a wavelength range of about 850 nm to about 1110 nm, such as is a wavelength range of infrared rays used in a remote control. In one exemplary embodiment, the infrared ray absorbing members 131 absorb light in a wavelength range of about 900 nm to about 1000 nm.

As in the illustrated embodiments, when the optical plate having the coating layer 130 is disposed above a light source that emits infrared rays in various wavelength ranges, it is possible to selectively block only infrared rays in the aforementioned wavelength range. Advantageously, any interference between the remote control and an electronic device including such a light source can be decreased or avoided, thereby reducing or effectively preventing a peripheral electronic device from malfunctioning or becoming inoperative.

In exemplary embodiments, the infrared ray absorbing members 131 may include made of any of a number of materials suitable for the purpose described herein, such as parylenes, antomony tin oxides (ATOs), lanthanum hexaborides (LaB₆), zirconium dioxides and a combination including at least one of the foregoing. In the illustrated exemplary embodiments, the infrared ray absorbing members 131 are made of a mixture of lanthanum hexaboride and zirconium dioxide. The mixture of the infrared ray absorbing members 131 may include about 98 wt % to about 99 wt % of resin, about 0.25 wt % to about 0.30 wt % of lanthanum hexaboride, and about 0.29 wt % to about 0.36 wt % of zirconium dioxide. In an exemplary embodiment, the resin includes a polycarbonate. In addition, the mixture may further include about 0.63 wt % to about 0.75 wt % of organic dispersing agent. The infrared ray absorbing members 131 may be added to the coating layer 130 in an amount of about 10 parts per million (ppm) to about 500 parts per million (ppm). The coating layer 130 may be made to have a thickness that is about 0.01% to about 10% of the total thickness of the optical plate.

As in the illustrated embodiments, the coating layer 130 may be provided on any one of the upper and lower skin layers 120a and 120b as shown in FIG. 1.

The coating layer 130 is not limited thereto but may be provided on each of the upper and lower skin layers 120a and 120b as shown in the variation of FIG. 2. In addition, a convexo-concave pattern may be provided in the surface of the skin layer 120 as shown in FIG. 3. In the illustrated embodiment, a micro lens-type pattern may be provided in the upper skin layer 120a and an embossing pattern may be provided in the lower skin layer 120b. Alternatively, the micro lens-type pattern may be provided on the lower skin layer 120b and the embossing pattern may be provided on the upper skin layer 120a. The patterns of skin layer and/or the coating layer may include any of a number of patterns including, but not limited to micro lens-type, embossing, prism or other profile that is suitable for the purpose described herein.

Now, an exemplary embodiment of a method for manufacturing the optical plate constructed as in FIG. 1 will be described with reference to the accompanying drawings.

An exemplary embodiment of an apparatus for manufacturing the optical plate of FIG. 1 according to the present invention will be explained as follows.

An exemplary embodiment of an apparatus for manufacturing the optical plate of FIG. 1 includes a raw material supply member 210 supplying a resin of the central layer 110 with the light diffusion materials 111 mixed therein and a resin of the skin layer 120, a forming member 220 forming the resins and a coating part 230 coating a UV curing agent with the infrared ray absorbing members 131 mixed therein.

The raw material supply member 210 includes a first storage unit 211 storing the resin of the central layer 110 with the light diffusion materials 131 mixed therein, a first injection unit 213 injecting the resin of the central layer 110, a second storage unit 212 storing the resin of the skin layer 120, and a second injection unit 214 injecting the resin of the skin layer 120. As shown in FIG. 4, a portion of the second injection unit 214 is positioned at opposing side regions of the first injection unit 213 and configured to dispense the resin of the skin layer 120 at opposing surfaces of the central layer 110. In this way, the resin of the skin layer 120 may be arranged at the both opposing (side) regions of the resin of the central layer 110.

The forming member 220 includes a plurality of rollers 221, 222, 223 and 224. In an exemplary embodiment, a predetermined pattern corresponding to a desired pattern on the skin layer 120 may be formed on surfaces (e.g., outer surfaces or outer diameters) of the rollers 221, 222, 223 and/or 224.

The coating part 230 includes a third storage unit 231 storing the UV curing agent with the infrared ray absorbing members 131 mixed therein, a third injection unit 232 injecting the UV curing agent, and a UV irradiating unit 233 curing the UV curing agent.

In the illustrated exemplary embodiment, the raw material supply member 210 injects a liquid resin of the central layer 110 and a liquid resin of the skin layer 120 such that the resin of the skin layer 120 is provided at both of opposing sides of the resin of the central layer 110. The forming member 220 cures the resin of the central layer 110 and the resin of the skin layer 120 to form a diffusion plate having the central layer 110 and the skin layers 120 provided at the both sides of the central layer 110. The rollers 221, 222, 223 and 224 of the forming member 220 can form a convexo-concave pattern on the surface of the skin layer 120 as shown in FIG. 3. In addition, it is possible to adjust the thickness of the diffusion plate by controlling gaps between adjacent rollers 221, 222, 223 and 224. In one exemplary embodiment, the diffusion plate has a thickness of about 1 millimeter (mm) to about 3 millimeters (mm), and the skin layer 120 has a thickness of about 50 microns (μm) to about 150 microns (μm).

The liquid UV curing agent with the infrared ray absorbing members 131 mixed therein is coated on the cured skin layer 120 by the coating part 230. Light with a wavelength of about 300 nm to about 400 nm is irradiated onto the cured skin layer 120 to cure the UV curing agent, thereby forming the coating layer 130 including the infrared ray absorbing member 131 on the skin layer 120.

Although FIG. 4 shows that the coating layer 130 is formed on the upper skin layer 120a, the present invention is not thereto and it is also possible to conduct the processes of coating and curing the UV curing agent again after turning over the diffusion plate or substantially simultaneously during a single coating and curing process. In this way, the coating layer 130 may also be formed on the lower skin layer 120b. Alternatively, a thermal curing agent may be used instead of the UV curing agent. As illustrated in the exemplary embodiment, the liquid UV curing agent with the infrared ray absorbing member mixed therein is coated and cured to form the coating layer 130. However, the present invention is not limited thereto and a separate coating layer 130 with the infrared ray absorbing member 131 may be prepared and then attached to the skin layer 120.

In an alternative exemplary embodiment, a PE (polyethylene) film having a plurality of through-holes and coating layers provided on upper and/or lower surfaces of the PE film may be disposed on the skin layer.

Now, another exemplary embodiment of an optical plate for a display according to the present invention will be explained. In the following description, descriptions of details overlapping with those of FIGS. 1-3 will be omitted. The following description can also be applied to the illustrated exemplary embodiments of FIGS. 1-3.

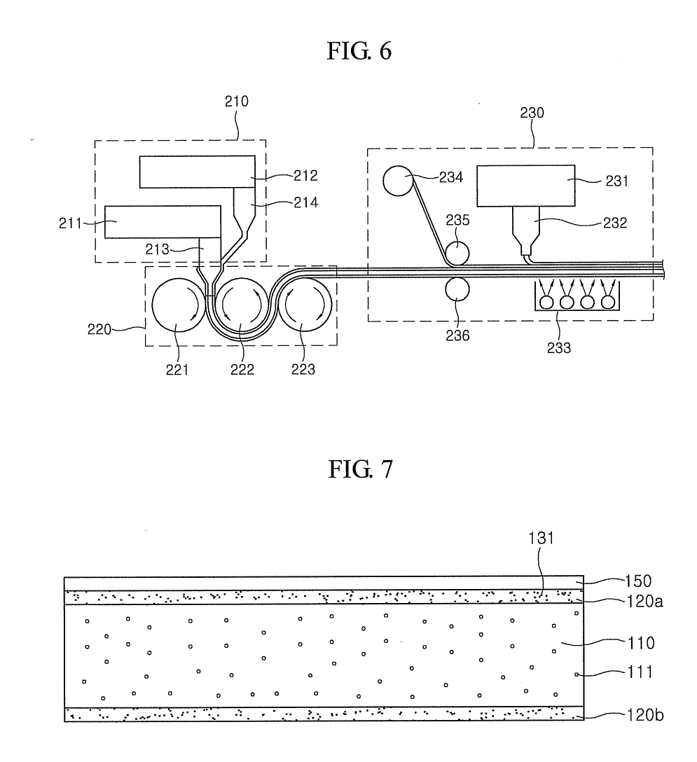

FIG. 5 is a schematic cross-sectional view showing another exemplary embodiment an optical plate for a display according to the present invention. FIG. 6 is a schematic view illustrating an exemplary embodiment of a method for manufacturing the optical plate of FIG. 5 for a display according to the present invention.

Referring to FIGS. 5 and 6, an optical plate includes a central layer 110, a skin layer 120 (120a, 120b) provided on the outer surface of the central layer 110, a PE film 140 provided on the skin layer 120 and having a plurality of through-holes 141, and a coating layer 130 provided on the PE film 140 and partially connected to and contacting the skin layer 120 through the through-holes 141 of the PE film 140. Infrared ray absorbing members 131 capable of absorbing infrared rays in a wavelength range of about 850 nm to about 1400 nm are provided in the coating layer 130.

In the illustrated exemplary embodiment, the PE film 140 is disposed on the skin layer 120 to protect the skin layer 120 against external factors (e.g., environments, impacts, contamination, etc.). In exemplary embodiments, it is possible to bond the PE film 140 to the skin layer 120 using the coating layer 130. When the PE film 140 having the plurality of through-holes 141 is disposed on the skin layer 120 and then coated with a UV curing agent of the coating layer 130, a portion of the liquid UV curing agent of the coating layer 130 flows into areas between the PE film 140 and the skin layer 120 through the through-holes 141. Thereafter, when the UV curing agent is cured, the UV curing agent flowing into the areas between the PE film 140 and the skin layer 120 as well as that portion coated on the upper surface of the PE film 140 are cured together. The UV curing agent between the PE film 140 and the skin layer 120 essentially acts as an adhesive bonding the PE film 140 and the skin layer 120 to each other.

In addition, since the infrared ray absorbing members 131 are contained in the coating layer 130, the infrared absorbing members 131 selectively absorb only infrared rays in a certain wavelength range. In the illustrated embodiment, the infrared ray absorbing members 131 selectively absorb only infrared rays in a wavelength range (e.g., about 850 nm to about 1100 nm), such as the wavelength used in a remote control.

FIG. 5 shows that the PE film 140 and the coating layer 130 are provided on the surface (e.g., an upper surface) of the upper skin layer 120a. However, the present invention is not thereto and it is also possible that the PE film 140 and the coating layer 130 are also provided on the surface (e.g., a lower surface) of the lower skin layer 120b.

The present invention is not limited to the PE film 140, and any of a number of stretched films capable of protecting the skin layer 120 may be used instead of the PE film 140. In one exemplary embodiment, polyester (e.g., PET (polyethylene terephthalate)) may be used. Alternatively, an optical film having various optical properties may be used instead of the PE film 140.

Now, an exemplary embodiment of a method for manufacturing the optical plate of FIG. 5 will be described with reference to the drawings.

An exemplary embodiment of an apparatus for manufacturing the optical plate of FIG. 5 according to the present invention will be explained as follows.

The apparatus for manufacturing the optical plate includes a raw material supply member 210 supplying a resin of the central layer 110 with the light diffusion materials 111 mixed therein and a resin of the skin layer, a forming member 220 forming the resins, and a coating part 230 coating the PE film 140 and the coating layer 130 including the infrared ray absorbing members 131.

The coating part 230 includes a roller 234 around which the PE film 140 is wound, coating rollers 235 and 236 coating the PE film 140 on the formed resin (e.g., diffusion plate), a third storage unit 231 storing the UV curing agent with the infrared ray absorbing members 131 mixed therein, a third injection unit 232 injecting the UV curing agent onto the PE film 140, and a UV irradiating unit 233 curing the UV curing agent. In the exemplary embodiment, a film having a plurality of through-holes 141 is used as the PE film 140. Alternatively, the PE film 140 is not limited thereto and a plurality of through-holes 141 may be formed in the PE film 140 before the PE film 140 is coated on the diffusion plate.

In the exemplary embodiment, the raw material supply member 210 injects a liquid resin of the central layer 110 and a liquid resin of the skin layers 120 provided at both of opposing sides of the resin of the central layer 110. The forming member 220 cures the resin of the central layer 110 and the resin of the skin layers 120 to form a diffusion plate having the central layer 110 and the skin layers 120 provided at the both sides of the central layer 110.

The PE film 140 having the plurality of through-holes 141 is disposed on an upper surface of the skin layer 120, and the liquid UV curing agent with the infrared ray absorbing member 131 mixed therein is coated on the PE film 140. The liquid UV curing agent permeates into an area between the PE film 140 and the skin layer 120 via the through-holes 141. Light with a wavelength of about 300 nm to about 400 nm is irradiated to cure the UV curing agent. The coating layer 130 is formed on the PE film 140, and the coating layer 130 partially permeates into the area between the PE film 140 and the skin layer 120 so that the PE film 140 and the skin layer 120 are bonded to each other.

In an exemplary embodiment, a skin layer having the infrared ray absorbing members 131 may be provided and an optical sheet is then attached to an upper surface of the skin layer 120. Infrared rays in a wavelength range of about 850 nm to about 1400 nm can be selectively blocked, and the optical sheet can be attached to the skin layer without using an additional adhesive.

Now, another exemplary embodiment of an optical plate for a display according to the present invention will be explained. In the following description, descriptions of details overlapping with those of the previous exemplary embodiments will be omitted. The following description can also be applied to the previous exemplary embodiments.

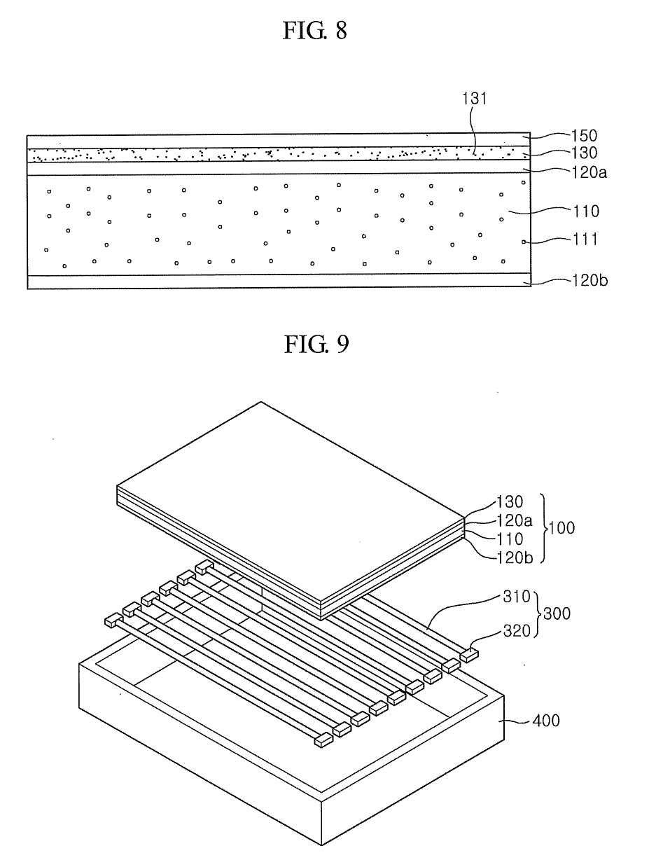

FIG. 7 is a schematic cross-sectional view showing another exemplary embodiment of an optical plate for a display according to the present invention. FIG. 8 is a schematic cross-sectional view showing an optical plate relative to the optical plate of FIG. 7 for a display according to the present invention.

Referring to FIG. 7, an optical plate includes a central layer 110, skin layers 120 (120a, 120b) provided on upper and lower surfaces, respectively, of the central layer 110, and an optical sheet 150 attached to an outer surface of one of the skin layers 120. Alternatively, the optical sheet 150 may be provided on both outer surfaces of the skin layers 120.

Light diffusion materials 111 are provided in the central layer 110, and infrared ray absorbing members 131 are provided in the skin layer 120. In the exemplary embodiment, the infrared ray absorbing members 131 absorbing infrared rays in a wavelength range, such as that used in a remote control, are provided in the skin layer 120. The infrared rays in the aforementioned wavelength range included in light emitted from an underlying light source (not shown) are absorbed by the skin layer 120 so that emission of the infrared rays to an outside of the optical plate is reduced or effectively prevented. In an exemplary embodiment, the skin layer 120 having the infrared ray absorbing members 131 is made by mixing the infrared ray absorbing members 131 with the resin of the skin layer 120.

As the optical sheet 150, it is possible to use various sheets capable of ensuring a substantially uniform luminance distribution of light emitted from the underlying light source. In one exemplary embodiment, a polarization sheet and/or a luminance-enhancing sheet may be used as the optical sheet 150.

In exemplary embodiments, the skin 120 including the infrared ray absorbing members 131 and the optical sheet 150 may be attached to each other without using an additional adhesive. The optical sheet 150 may be placed on the skin layer 120 including the infrared ray absorbing members 131, and light in a wavelength range absorbed by the infrared ray absorbing members 131 may be irradiated using a laser. The infrared ray absorbing members 131 provided in the skin layer 120 are heated by a laser ray with high energy, and the skin layer 120 is partially melted by the heated infrared ray absorbing members 131, such that the skin layer 120 is bonded to the optical sheet 150. In this way, the skin layer 120 and the optical sheet 150 are bonded to each other without using a separate adhesive.

The present invention is not limited thereto but may be variously modified. As shown in FIG. 8, the coating layer 130 including the infrared ray absorbing members 131 is coated on the skin layer 120. The optical sheet 150 may be attached to an upper surface of the coating layer 130 using irradiation of infrared rays using a laser.

Although it is illustrated in the figure that the optical sheet 150 is attached to the upper surface of the upper skin layer 120a, the invention is not limited thereto and the optical sheet 150 may be attached to a lower surface of the lower skin layer 120b. In addition, in the illustrated exemplary embodiments, the infrared ray absorbing members 131 have been described as being provided in the skin layer 120 or the coating layer 130. However, the present invention is not limited thereto and the infrared ray absorbing members 131 may be provided in the optical sheet 150 to block infrared rays in the desired wavelength range mentioned above and the skin layer 120 and the optical sheet 150 can be bonded to each other.

Now, exemplary embodiments of backlight assemblies having the optical plates for a display according to the present invention will be explained.

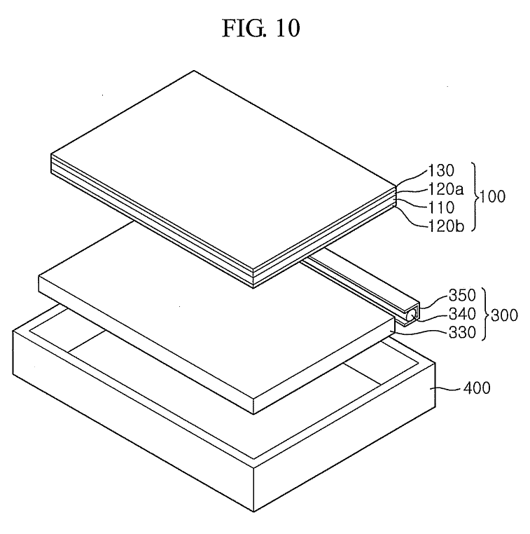

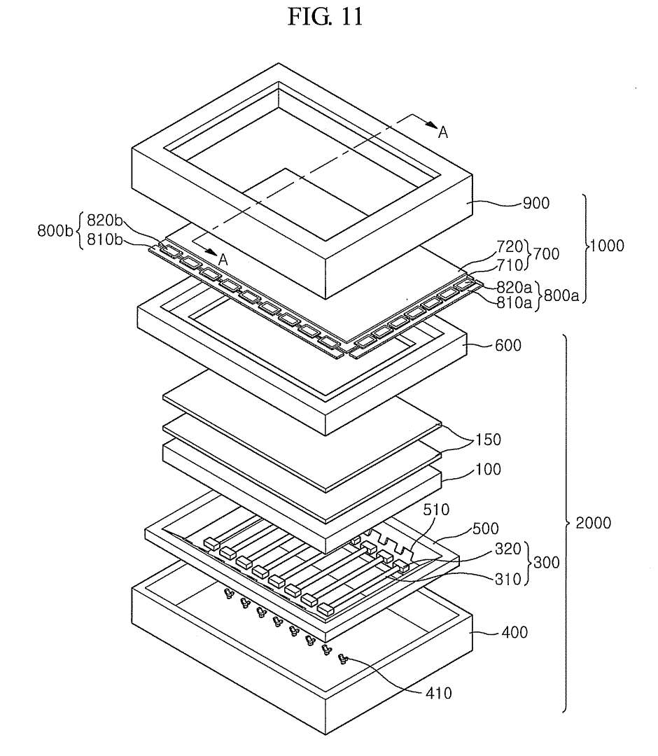

FIG. 9 is a perspective view schematically showing an exemplary embodiment of a backlight assembly according to the present invention. FIG. 10 is a perspective view schematically showing an exemplary embodiment of a backlight assembly relative to the backlight assembly of FIG. 9 according to the present invention.

Referring to FIG. 9, a backlight assembly includes a light source unit 300, an optical plate 100 provided above the light source unit 300, and a receiving member 400 receiving the light source unit 300 and the optical plate 100.

The light source unit 300 includes a plurality of lamps 310, and lamp holders 320 provided at both ends of each of the lamps 310 to support and fix the lamps 310. Cold cathode fluorescent lamps may be used as the plurality of lamps 310. The present invention is not limited thereto and all kinds of lamps capable of emitting light in an infrared ray wavelength range as well as a visible ray (i.e., white light) wavelength range may be used as the lamps 310. The cold cathode fluorescent lamp includes a glass tube including a mixture of Hg, Ne and Ar, an anode and a cathode provided at both ends of the glass tube, and a phosphor film coated on an inner surface of the glass tube.

In the cold cathode fluorescent lamp, electrons emitted through an electric field applied between the anode and cathode causes a phase transition of Hg to emit light in a predetermined wavelength range, and the phosphor converts the light in the wavelength range into visible rays that in turn are emitted. In case of the cold cathode fluorescent lamp, the temperature of the lamp is not sufficiently stabilized at an initial lighting stage, thereby increasing the amount of infrared rays to be emitted.

Where the lamp 310 has a temperature over a certain temperature (e.g., about 50° C.), Hg in the glass tube is sufficiently evaporated to represent normal light emission of Hg. However, if the temperature of the lamp 310 is relatively low, Hg is not sufficiently evaporated and the mixed Ne and Ar gases provide light emission. Thus, a great deal of infrared rays in a relatively broad wavelength range is emitted through the lamps 310. Infrared rays in a range of about 850 nm to about 1400 nm included in the infrared rays emitted from the lamps 310 may cause interference with infrared rays outputted from a remote control, thereby causing a phenomenon in which a peripheral electronic device malfunctions or becomes inoperative during a certain period of time. As in the illustrated exemplary embodiment, the optical plate 100 having a coating layer 130 including the infrared ray absorbing members is disposed above the light source unit 300 to reduce or prevent infrared rays from being emitted outside the backlight assembly.

The optical plate 100 illustrated in FIG. 9 includes a central layer 110 including light diffusion materials, skin layers 120 (120a, 120b) provided on upper and lower surfaces, respectively, of the central layer 110, and the coating layer 130 coated on one of the skin layers 120 and including infrared ray absorbing members. In the optical plate 100, visible rays (or white light) emitted from the light source unit 100 are uniformly diffused by the light diffusion materials provided in the central layer 110.

In addition, infrared rays in a wavelength range of about 850 nm to about 1400 nm are selectively absorbed by the infrared ray absorbing members in the coating layer 130. The infrared rays in a wavelength range of about 850 nm to about 1400 nm emitted from the light source unit 300 are absorbed by the coating layer 130 and are not emitted outside the coating layer 130 of the optical plate 100. Advantageously, it is possible to reduce or effectively prevent the aforementioned optical interference with a remote control. The optical plate 100 is not limited to the configuration of the illustrated exemplary embodiment, but may employ the configurations described in connection with the previous exemplary embodiments and related exemplary embodiments of the optical plate for a display.

In an exemplary embodiment, the light source unit 300 of the backlight assembly may include a light guide plate 330, a lamp 340 provided at one side of the light guide plate 330, and a lamp cover 350 guiding light from the lamp 340 toward the light guide plate 330, as shown in FIG. 10. The light guide plate 330 converts the light of the lamp 340 having a light distribution of a linear light source into light having a light distribution of a surface light source. Infrared rays in a wavelength of about 850 nm to about 1400 nm generated from the lamp 340 are also emitted to the front of the light guide plate 330. Since the optical plate 100 having the coating layer 130 including the infrared ray absorbing members is disposed above the light guide plate 330, the infrared rays in a wavelength of about 850 nm to about 1400 nm are absorbed by the infrared ray absorbing members in the coating layer 130 and thus are not emitted outside the optical plate 100.

Now, an exemplary embodiment of a liquid crystal display (“LCD”) having a backlight assembly according to the present invention will be explained.

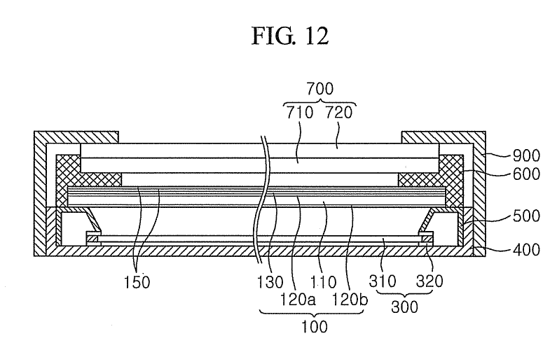

FIG. 11 is a perspective view schematically showing an exemplary embodiment of an LCD according to the present invention, and FIG. 12 is a schematic cross-sectional view taken along line A-A in the LCD shown in FIG. 11.

Referring to FIGS. 11 and 12, an LCD includes a display assembly 1000 arranged at an upper portion of the LCD, and a backlight assembly 2000 arranged at a lower portion of the LCD.

The display assembly 1000 includes an LCD panel 700, a driving circuit unit 800 (800a, 800b), and an upper receiving member 900.

The LCD panel 700 includes a color filter substrate 720, and a thin film transistor (“TFT”) substrate 710. The driving circuit unit 800 includes a gate-side printed circuit board 810a connected to gate lines of the TFT substrate 710 through a gate-side flexible printed circuit board 820a, and a data-side printed circuit board 810b connected to data lines of the TFT substrate 710 through a data-side flexible printed circuit board 820b. In an exemplary embodiment, the gate-side printed circuit board 810b may be omitted.

The upper receiving member 900 is made in a substantially rectangular frame-like shape with a planar portion and sidewall portions perpendicularly bent and extending from the planar portion so as to prevent components of the display assembly 1000 from becoming detached as well as to protect the LCD panel 700 and/or the backlight assembly 2000, which is vulnerable to external impact. The upper receiving member 900 includes an opening in the planar portion considered as a display region. The planar portion of the upper receiving member 900 partially supports edges of the LCD panel 700 below the planar portion. The sidewall portions of the upper receiving member 900 are engaged with corresponding sidewalls of a lower receiving member 400. In an exemplary embodiment, the upper receiving member 900 and the lower receiving member 400 are made of a metal having superior strength, relatively light weight and small deformation characteristics.

The backlight assembly 2000 includes a light source unit 300 generating light, a fixing member 500 supporting and fixing the light source unit 300, an optical plate 100 arranged on the (lamp) fixing member 500, an optical sheet 150 arranged on the optical plate 100, a support part 600 supporting the optical plate 100 and the optical sheet 150, and a lower receiving member 400 receiving the light source unit 300, the fixing member 500, the optical plate 100 and the optical sheet 150.

The light source unit 300 includes a plurality of lamps 310 arranged at a regular interval, and lamp holders 320 provided at ends of each of the lamps 310. In the exemplary embodiment, the lamps 310 are arranged such that a lengthwise direction of the lamps 310 is perpendicular to a longitudinal direction of the lower receiving member 400. The arrangement of lamps 310 is not limited thereto but may be arranged such that the lengthwise (e.g., longitudinal) direction of the lamps 310 is substantially parallel with the longitudinal direction of the lower receiving member 400.

The fixing member 500 is shaped in the form of a frame with an open lower face. A plurality of concave portions 510 are provided at a side (e.g., one side) of the fixing member 500 so as to support and fix the lamp holders 320 of the light source unit 300. The fixing member 500 supports and fixes the plurality of lamps 310 of the light source unit 300 to reduce or effectively prevent shaking or movement of the lamps 310 and to protect the lamps 310 against external impact. The fixing member 500 is not limited to the above configuration but may be modified into various configurations capable of supporting and fixing the plurality of lamps 310 of the light source unit 300.

The optical plate 100 provided on the fixing member 500 includes a central layer 110 including light diffusion materials, skin layers 120 (120a, 120b) provided on the surfaces of the central layer 110, and a coating layer 130 coated on one of the skin layers 120 and including infrared ray absorbing members.

The central layer 110 having the light diffusion materials directs light inputted from the light source unit 300 to the front of the LCD panel 700, diffuses the light to have a substantially uniform distribution in a relatively wide area and irradiates the diffused light onto the LCD panel 700. The coating layer 130 including the infrared ray absorbing members absorbs light in a wavelength range of about 850 nm to about 1400 nm included in the incident light from the light source unit 300, and transmits remaining light in the other wavelength ranges from the light source unit 300. The emission of light in a wavelength range of about 850 nm to about 1400 nm to outside of the optical plate 100 is reduced or effectively prevented. Advantageously, it is possible to reduce or effectively prevent an optical interference phenomenon that may occur between the LCD including an optical plate of the exemplary embodiments and a remote control.

In exemplary embodiments, the optical sheet 150 may include a polarization sheet and a luminance-enhancing sheet. The polarization sheet functions to change slantly or inclined incident light included in light incident on the polarization sheet so that the light can be outputted in a substantially perpendicular direction to the polarization sheet. The luminance-enhancing sheet transmits light parallel with a transmission axis of the luminance-enhancing sheet but reflects light perpendicular to the transmission axis. In this way, light is caused to be incident in a direction perpendicular to the LCD panel 700, thereby improving light efficiency.

As in the illustrated exemplary embodiment, the optical plate 100 may further have a PE film provided in an area between the skin layer 120 and the coating layer 130. The optical sheet 150 may be attached to the coating layer 130. In addition, it is also possible to provide a skin layer 120 including the infrared ray absorbing members and to attach the optical sheet 150 on the skin layer without forming the coating layer 130.

As in the illustrated exemplary embodiment, the support part 600 is made in a substantially rectangular frame-like shape and supports the optical plate 100 and the optical sheet 150. The support part 600 also supports the LCD panel 700 disposed above the supporting part 600.

As in the illustrated exemplary embodiment, the lower receiving member 400 is made in a substantially rectangular hexahedral box shape with an open upper face so that a receiving space with a predetermined depth is defined therein. A plurality of lamp fixing members 410 may be provided in the lower receiving member 400 so as to support the lamps of the light source unit 300, thereby reducing or preventing sagging, drooping and/or damage to the lamps 310 due to external impact. Alternatively, it is also possible for a plurality of fixing members 410 to support one lamp 310. In addition, a reflecting plate (not shown) may be provided at a bottom surface of the lower receiving member 400.

As in the illustrated embodiment, emission of infrared rays in a certain wavelength range included in output light from a light source unit can be reduced or effectively prevented by arranging an optical plate having a coating layer including infrared ray absorbing members above the light source unit.

As in the illustrated embodiment, optical interference between a light source unit and a remote control can be reduced or effectively prevented using the infrared ray absorbing members that absorb infrared rays in the same wavelength range as that of infrared rays from the remote control.

As in the illustrated embodiments, an optical sheet can be bonded to a skin layer only with irradiation of infrared laser rays without using an adhesive, such as providing the infrared ray absorbing members in the skin layer of a diffusion plate.

Although the present invention has been described in connection with exemplary embodiments and the drawings, the present invention is not limited thereto. The scope of the present invention is defined by the appended claims. Thus, it will be apparent to those skilled in the art that various changes and modifications can be made thereto without departing from the technical spirit and scope of the invention defined by the appended claims.

What is claimed is:

1. An optical plate for a display, the optical plate comprising:
a central layer including light diffusion materials;
a skin layer disposed on the central layer; and
a coating layer disposed on the skin layer and including infrared ray absorbing members including one material of parylenes, antomony tin oxides, lanthanum hexaborides, zirconium dioxides and a combination including at least one of the foregoing.

2. The optical plate of claim 1, wherein the infrared ray absorbing members further include an organic dispersing agent and a resin.

3. The optical plate of claim 1, further comprising an optical sheet attached to the coating layer.

4. The optical plate of claim 1, wherein the central layer and the skin layer are made of a same light transmitting resin, the skin layer is disposed at each of upper and lower surfaces of the central layer, and the coating layer is disposed on at least one of the skin layers.

5. The optical plate of claim 1, wherein the coating layer is disposed on both of the skin layers.

6. The optical plate of claim 1, wherein the central layer and the skin layer are made of different light transmitting resins, the skin layer is disposed at each of upper and lower surfaces of the central layer, and the coating layer is disposed on at least one of the skin layers.

7. The optical plate of claim 1, further comprising a film layer disposed on the skin layer.

8. The optical plate of claim 7, wherein the film layer includes a plurality of through-holes, and the coating layer extends into the through-holes and connects to the skin layer.

9. The optical plate of claim 7, wherein the infrared ray absorbing members further include an organic dispersing agent and a resin.

10. The optical plate of claim 7, further comprising an optical sheet attached to the coating layer.

11. A method for manufacturing an optical plate for a display, the method comprising:
forming a diffusion plate including a central layer including light diffusion materials and skin layers disposed on upper and lower surfaces of the central layer;
coating a light or thermal curing agent including infrared ray absorbing members on the diffusion plate; and
curing the curing agent including irradiating light or heat, respectively, to the curing agent and forming a coating layer including the infrared ray absorbing members on the diffusion plate.

12. The method of claim 11, further comprising:
providing an optical sheet on the coating layer, irradiating laser rays in a wavelength range of about 850 nanometers (nm) to about 1400 nanometers (nm) and bonding the optical sheet to the coating layer.

13. The method of claim 11, further comprising:
disposing a film layer including a plurality of through-holes on the diffusion plate.

14. The method of claim 13, further comprising:
providing an optical sheet on the coating layer, irradiating laser rays in a wavelength range of about 850 nanometers (nm) to about 1400 nanometers (nm) and bonding the optical sheet to the coating layer.

15. A backlight assembly, comprising:
a light source unit emitting light;
an optical plate disposed above the light source unit and including infrared ray absorbing members including one material of parylenes, antomony tin oxides, lanthanum hexaborides, zirconium dioxides and a combination including at least one of the foregoing; and
a receiving member receiving the light source unit and the optical plate.

16. The backlight assembly of claim 15, wherein the optical plate further includes:
a diffusion plate; and
a coating layer disposed on the diffusion plate and including the infrared ray absorbing members.

17. The backlight assembly as claimed in claim 15, wherein the optical plate further includes:
a diffusion plate;
a film layer disposed on the diffusion plate; and
a coating layer including the infrared ray absorbing members and connected to an upper surface of the film layer and to a surface of the diffusion plate while penetrating through the film layer.

18. The backlight assembly as claimed in claim 15, wherein the optical plate further includes:
a central layer including light diffusion materials;
skin layers disposed on upper and lower surfaces of the central layer and including the infrared ray absorbing members; and
an optical sheet bonded to at least one of the skin layers.

19. A liquid crystal display, comprising:
a liquid crystal display panel displaying images thereon;
a backlight assembly irradiating light to the liquid crystal display panel; and
a receiving member receiving the liquid crystal display panel and the backlight assembly,
wherein the backlight assembly includes a light source unit emitting light and an optical plate disposed above the light source unit, the optical plate including a coating layer made of a light or thermal curing agent including infrared ray absorbing members.

20. The liquid crystal display of claim 19, wherein the infrared ray absorbing members include one material of parylenes, antomony tin oxides, lanthanum hexaborides, zirconium dioxides and a combination including at least one of the foregoing.
